(19) United States
(12) Patent Application Publication
(10) Pub. No.: US 2023/0237455 A1
(43) Pub. Date: Jul. 27, 2023

(54) METHODS AND SYSTEMS FOR DIGITAL UPGRADES AND DOWNGRADES ON A TRANSPORTATION VEHICLE

(71) Applicant: Panasonic Avionics Corporation, Irvine, CA (US)

(72) Inventor: Kenneth William Sain, Ladera Ranch, CA (US)

(21) Appl. No.: 18/097,926

(22) Filed: Jan. 17, 2023

Related U.S. Application Data
(60) Provisional application No. 63/267,119, filed on Jan. 25, 2022.

(51) Int. Cl. G06Q 20/12; G06Q 50/30

(52) U.S. Cl. CPC G06Q 20/1235; G06Q 50/30

(57) ABSTRACT

Methods and systems are provided for a transportation vehicle. One method includes retrieving information before a flight for an aircraft, the information including passenger fare purchase data, passenger seat location data, aircraft configuration defining a layout of the aircraft, functions available on the flight controlled by an in-flight entertainment (IFE) system; prior to the flight, generating a digital rights object for the aircraft, the digital rights object defining media content and functionality that will be made available to each passenger at a passenger seat; parsing the digital rights object to map media content and functionality for each passenger seat; and enabling by the IFE system, an upgrade or downgrade of digital rights of a passenger as defined by the digital rights object.

### CROSS-REFERENCE TO RELATED APPLICATION

This patent application claims priority under 35 USC § 119 (e) to U.S. Provisional Patent Application Ser. No. 63/267,119 filed on Jan. 25, 2022, the disclosure of which is incorporated herein by reference in its entirety.

### TECHNICAL FIELD

The present disclosure relates to transportation vehicles in general, and more particularly, to digital upgrades and downgrades on aircrafts and other transportation vehicle types.

### BACKGROUND

Transportation vehicles, for example, aircraft, trains, buses, recreation vehicle, boats and other similar vehicles use various computing devices for providing various functions, including entertainment, system control, content storage, and other functions. These computing devices include hardware (for example, servers, switches, network interface cards, storage adapters, storage devices and others) and software (for example, server applications, operating systems, firmware, management applications, application programming interface (APIs) and others).

Transportation vehicles today have individualized functional equipment dedicated to a particular passenger seat, which can be utilized by a passenger, such as adjustable seats, adjustable environmental controls, adjustable lighting, telephony systems, video and/or audio entertainment systems, crew communication systems, and the like. For example, many commercial airplanes have individualized video and audio entertainment systems, often referred to as “in-flight entertainment” or “IFE”/“IFEC” (In-flight entertainment and connectivity) systems, used interchangeably throughout this specification.

It has become quite commonplace for travelers to also carry personal electronic devices (PEDs) having wireless communication capability, such as cellular phones, smart phones, tablet computers, laptop computers, and other portable electronic devices. This includes passengers and crew traveling on all types of transportation including the vehicles of common carriers, such as airplanes, passenger trains, buses, cruise ships, sightseeing vehicles (e.g., ships, boats, buses, cars, etc.). Many of these personal electronic devices have the capability to execute application software programs (“apps”) to perform various functions, including controlling other devices and systems.

Continuous efforts are being made to develop technology that can enable aircrafts and other transportation vehicles to dynamically upgrade and downgrade digital content and functionality that allows airlines and transportation carriers to segment passenger cabins, differentiate service offerings and pricing.

### BRIEF DESCRIPTION OF THE DRAWINGS

The various features of the present disclosure will now be described with reference to the drawings of the various aspects disclosed herein. In the drawings, the same components may have the same reference numerals. The illustrated aspects are intended to illustrate, but not to limit the present disclosure. The drawings include the following Figures:

FIG. 1A shows a graphical illustration of a conventional price and service relationship;

FIG. 1B shows a graphical illustration of a conventional price and service relationship which includes “premium economy”;

FIG. 1C shows a graphical illustration of digital upgrade/downgrade based on the innovative technology of the present disclosure;

FIG. 1D shows a digital upgrade/downgrade system using the innovative technology of the present disclosure;

FIG. 1E shows a process flow diagram for digital upgrades/downgrades, according to one aspect of the present disclosure;

FIG. 1F shows a process flow diagram for presenting digital content, according to one aspect of the present disclosure;

FIG. 2A shows an example of an operating environment for implementing the various aspects of the present disclosure on an aircraft;

FIG. 2B shows an example of the operating environment on a non-aircraft transportation vehicle type, according to one aspect of the present disclosure;

FIG. 2C shows an example of a content distribution system, used according to one aspect of the present disclosure;

FIG. 3 shows another example of an overall system for digital upgrades/downgrades, according to one aspect of the present disclosure; and

FIG. 4 shows a block diagram of a computing system, used according to one aspect of the present disclosure.

### DETAILED DESCRIPTION

In one aspect, innovative processor executable systems and methods are disclosed to dynamically upgrade and downgrade any aircraft (or any other transportation vehicle, as described below) seat's digital content and/or functionality (or features, used interchangeably throughout this specification) provided by an IFE/IFEC (used interchangeably throughout this specification) system on each flight. The term digital content upgrade and downgrade as used herein, without limitation, includes ability to select or deselect movies, pre-recorded television series, live television, pay-per-view events, live sporting events, video games, collaborative video games, sports network content, audio content or any other content. A non-exhaustive list of upgradeable and downgrade able passenger seat specific features include generic feature lock or unlock for specific seat for passenger usage/availability, such as displaying advertisements on the IFE directed to specified products/services, Bluetooth access and Wi-Fi access for tablets and mobile devices, power access for tablets or mobile devices, overhead storage bin availability for luggage storage and/or recent passenger purchases, seat arm control functionality including availability for pairing with passenger Bluetooth devices, overhead lighting brightness at takeoff/middle flight/end of flight state, lavatory availability, Internet, purchasing products/services on Internet, credit limit for purchasing product/services on Internet sites, Internet sites/company sites pre-approved for browsing/purchasing products/services, number of crew/attendant availability or priority for passenger service, or the like. This enables airlines to further segment a passenger cabin, differentiate service offerings and price.

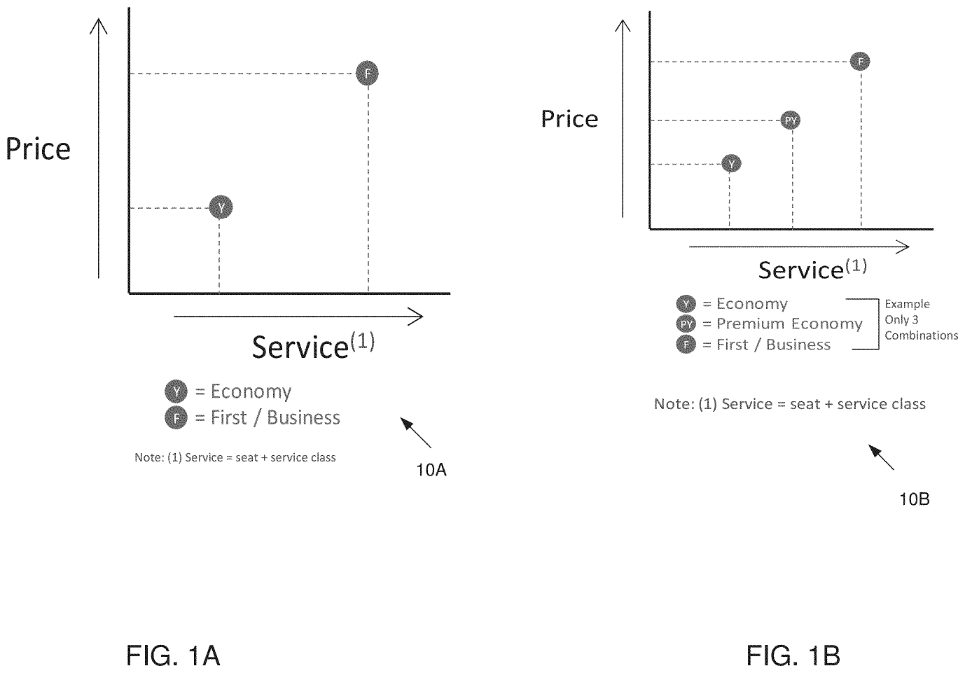

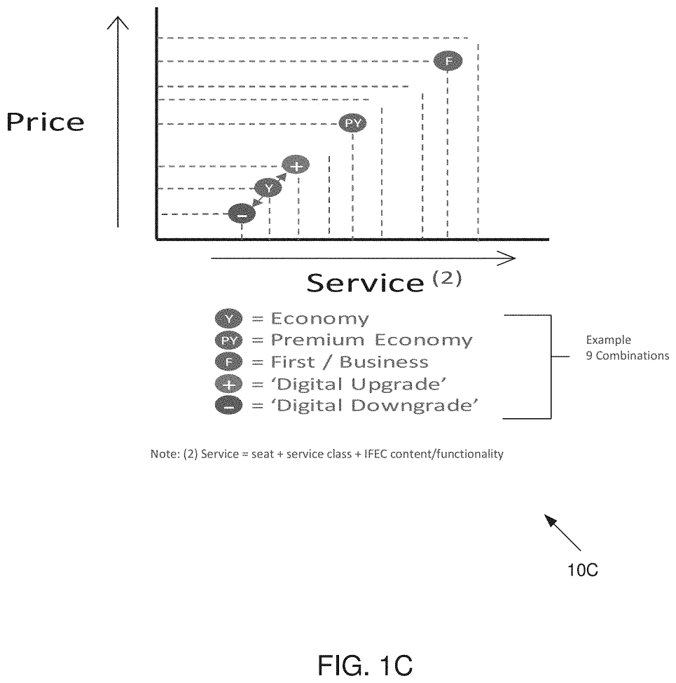

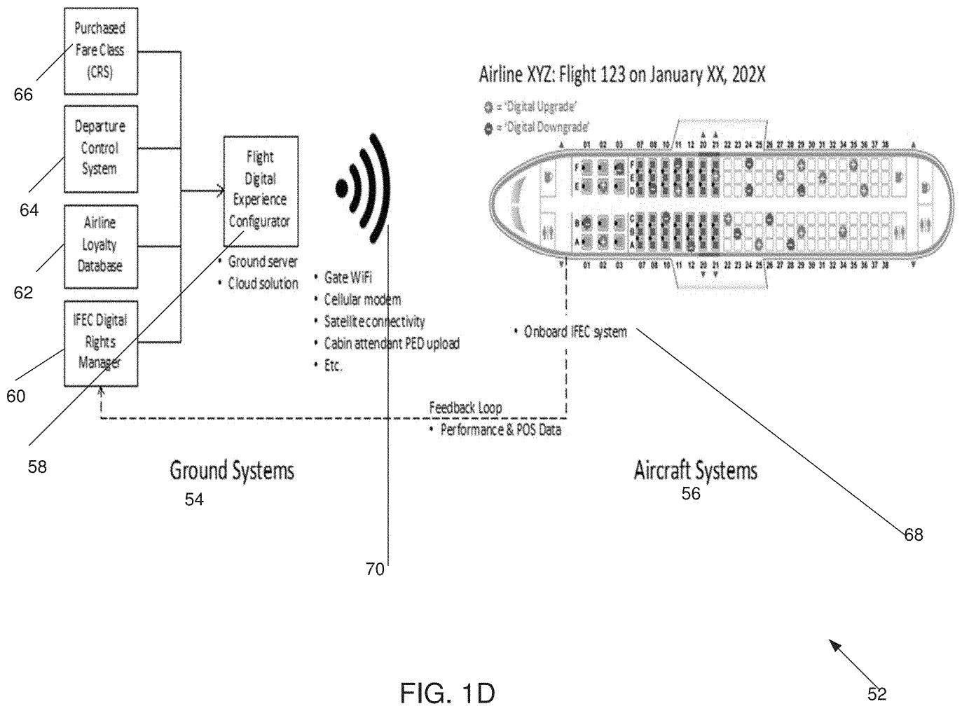

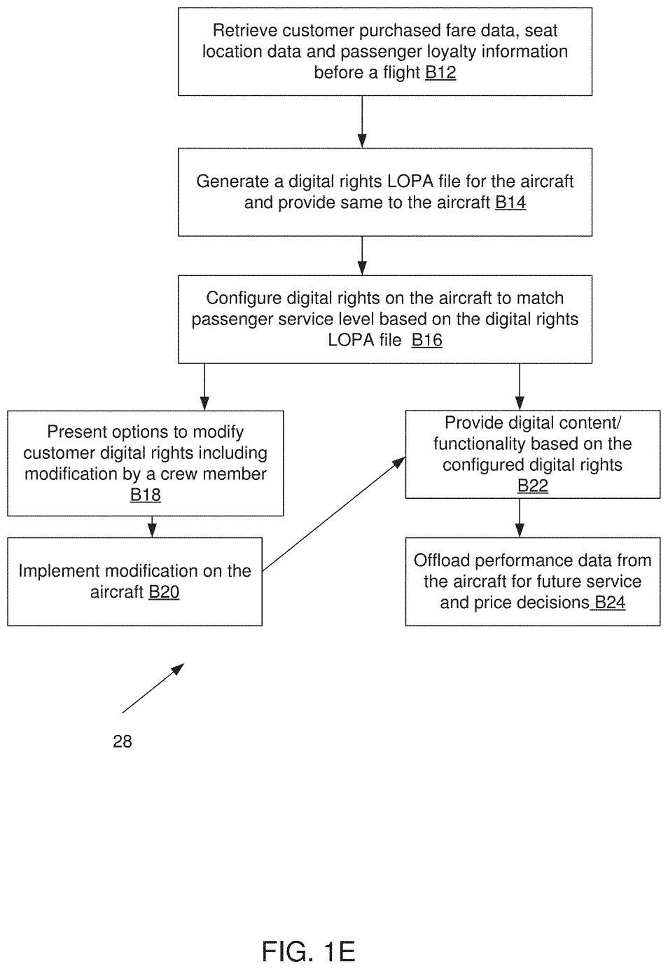

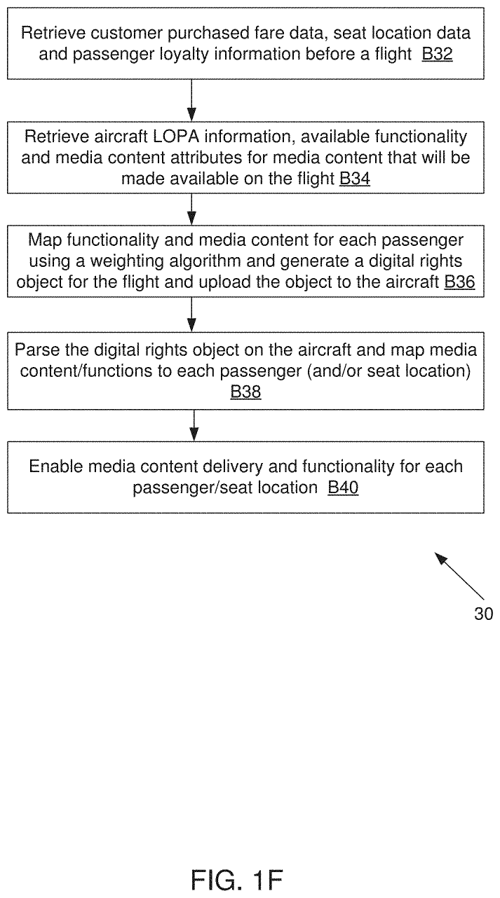

Today, using conventional technology, airlines traditionally differentiate onboard services typically by cabin class (i.e., first/business class, economy, shown as 10A in FIG. 1A). This approach often results in two (first/business, economy) or three (first, business, economy) service offerings at point-of-sale global distribution systems.

Today customers demand various service levels, are willing to pay for such services, and this may result in different competitive services and price offerings. To accommodate these different options, it is desirable to have more service offerings/features/price points (and resultant fare classes), which allows airlines to better meet customer service level demands. The customer willingness to pay also increases airline revenue. As an example, a growing trend for airlines is to further segment a typical economy cabin with a ‘premium economy’ (see 10B, FIG. 1B) segment featuring a greater seat pitch than economy with a more desirable seat location closer to the front of the aircraft allowing for quicker deplaning. This allows the airline to offer an additional passenger experience category to better match service options to demand and customer willingness to pay (or loyalty level).

Today's cabin class service differentiation is primarily through the physical characteristics of each seat (e.g., seat row, seat width, seat pitch, aisle/middle/window, etc.) as defined by cabin class and the provided passenger service, food and beverage.

Unfortunately, the physical characteristics of a seat (as represented by a cabin LOPA (Location of Passenger Accommodations)) is fixed and is difficult to change to match customer demands on a route. Airlines typically don't change LOPA's for many years due to the time and cost to modify and reconfigure an aircraft cabin. Furthermore, the cost and complexity to upgrade or downgrade passenger service levels and food and beverage across the cabin and/or outside of typical cabin classes is also high and/or difficult. The present disclosure solves these problems by providing innovative technology, as described below in detail.

In one aspect, the present disclosure provides technology for systems and methods to leverage an onboard, IFEC system of an aircraft to dynamically segment aircraft cabin service levels (e.g., varying availability of media content and/or seat specific features/functions) for each flight, at every IFEC provisioned seat at a point-of-sale and/or onboard the aircraft through self-service, paid upgrades.

At the point-of-sale, the disclosed technology enables customers to select service levels/price options that include digital content, features and functionality available from the IFEC system at the seat of their choosing. Some customers may choose a lower cost fare that excludes one or more features and functionality of the IFEC system or includes a certain level of paid advertisements while onboard. Other customers may choose a higher fare that includes additional digital content or functionality on a flight. This also allows airlines with IFEC systems to better match or differentiate their service levels and pricing at each IFEC seat to competitors that may not provide IFEC services onboard.

Additionally, some customers may purchase a fare without IFEC content but then decide on board that they would like to purchase IFEC services/features resulting in self-service, onboard ancillary revenue for airlines. Reference number 10C of FIG. 1C graphically illustrates digital downgrades and upgrades using the innovative technology disclosed herein. As compared to fare/service offerings across typical classes of service, digital upgrades would increase available service offerings, e.g., by a factor of 3 and present customers with more service/price options for each class of service (digital upgrade and digital downgrade), in contrast to the limited options available in conventional systems described above.

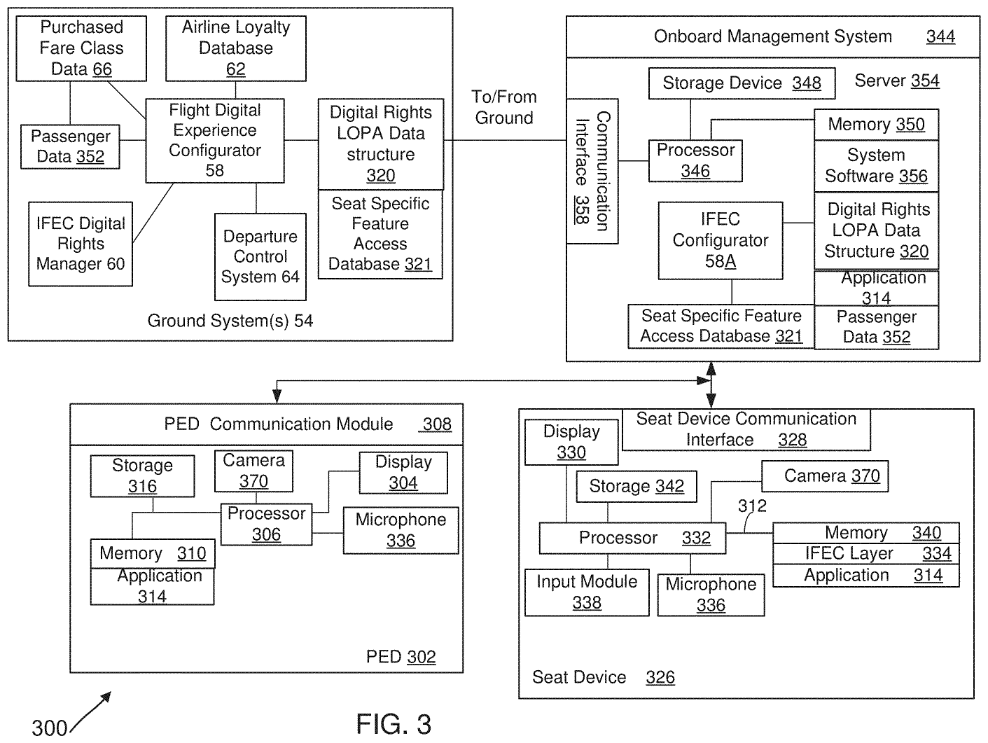

In one aspect, the innovative technology disclosed herein enables any IFEC equipped seat on an aircraft to be dynamically upgraded or downgraded before a flight based upon a fare class purchased and upgraded onboard via a self-service portal for a fee. The disclosed system integrates purchased fare class information for each seat on each flight to lock or unlock IFEC digital content and/or functionality. Therefore, on one flight a seat could be ‘digitally downgraded’ and on a following flight the same seat could be ‘digitally upgraded’ allowing the airline more offerings to satisfy customer service level demand and willingness to pay. In one variation of this aspect, digitally upgrading/downgrading of functionality refers to the use of a seat specific feature access database (e.g., 321, FIG. 3), that may provide, e.g., generic feature lock or unlock for specific seat for passenger usage/availability, such as displaying advertisements on the IFE directed to specified products/services, Bluetooth access and Wi-Fi access for tablets and mobile devices, power access for tablets or mobile devices, overhead storage bin availability for luggage storage and/or recent passenger purchases, lavatory availability, seat arm control functionality including availability for pairing with passenger Bluetooth devices, overhead lighting brightness at takeoff/middle flight/end of flight state, Internet, purchasing products/services on Internet, credit limit for purchasing product/services on Internet sites, Internet sites/company sites pre-approved for browsing/purchasing products/services, number of crew/attendant availability for passenger service, or the like. The term database as used herein includes relational databases, unstructured databases or any other data structure type.

In another aspect, the innovative system disclosed herein allows customers to buy IFEC content and functionality/feature upgrades onboard the flight to provide airlines with additional ancillary revenue.

In one aspect, the disclosed system operates by incorporating (a) customer purchased fare class data (e.g., 66, FIG. 1D), (b) seat location data (from a departure control system (e.g., 64, FIG. 1D)), (c) airline loyalty database (e.g., 62, FIG. 1D) (for loyalty-based rights irrespective of fare class), and (d) ground and/or cloud-based digital rights management solution (e.g., 60, FIG. 1D) to manage what rights/features are to be assigned to passenger seats onboard each flight.

This information is analyzed by an IFEC ground based system (and/or server, including a cloud based system, e.g., IFEC ground server and/or Cloud-based server) (e.g., 54, FIG. 1D) to generate a Digital Rights LOPA file (or data structure or data object, or data container, used interchangeably throughout this specification) 320 and the seat specific feature access database 321 to be transmitted to the aircraft before each flight via a ground Wi-Fi, cellular or satellite Wi-Fi services. It is noteworthy that the digital rights data structure 320 may be integrated with the seat specific feature access database 321 but for convenience is shown separately.

An onboard aircraft IFEC system configures the digital rights and seat specific features onboard the aircraft before each flight to match service levels planned for each customer to their intended seat. Flight crew may have a locally managed digital rights transfer portal to accommodate situation in which a passenger is seated in a location other than previously assigned.

For seats with downgraded IFEC content and/or functionality, the IFEC system enables the airline to present customers with options to ‘upgrade’ the IFEC content or functionality for a fee through an IFEC portal. Data regarding the performance of the system and additional self-service upgrades is offloaded at the end of each flight for airline analysis and future service and price decisions.

FIG. 1D shows an example of a system 52, according to one aspect of the present disclosure. System 52 includes the ground systems 54 and the aircraft systems 56, described below in detail. The ground systems 54 include a flight digital experience configurator 58 (may also be referred to as configurator 58) that may be a processor executable application, a cloud-based container or micro-service or any other entity. Configurator 52 interfaces with various subsystems, e.g., the purchased fare class data structure 66 that provides passenger fare information, the departure control system 64 that provides aircraft LOPA information including seat locations of specific aircrafts for specific flights, the airline loyalty database 62 that provides passenger loyalty information, and the IFEC digital rights manager 60, a cloud-based container or microservice, that generates the digital rights object (which may also include the seat specific feature access database 321 (FIG. 3)) based on which content and/or functionality is made available during a flight. The digital rights object and the seat specific feature access database is provided to the aircraft IFEC system 68 via a network connection 70 that may include a gate Wi-Fi connection, a cellular modem connection, a satellite connection or from a personal crew member device. The adaptive aspects of the present disclosure are not limited to any specific connection type.

The onboard IFEC system 68 configures the digital rights and seat specific features before each flight to match the service levels for each customer and their intended seat. If a passenger is seated at a different location, a flight crew member using an aircraft portal or crew electronic device can modify the passenger's service levels, before the passenger moved. In one aspect, digitally upgrading/downgrading of functionality refers to the use of the seat specific feature access database 321 that may provide, e.g., generic feature lock or unlock for specific seat for passenger usage/availability, such as displaying advertisements on the IFE directed to specified products/services, Bluetooth access and Wi-Fi access for tablets and mobile devices, power access for tablets or mobile devices, overhead storage bin availability for luggage storage and/or recent passenger purchases, seat arm control functionality including availability for pairing with passenger Bluetooth devices, overhead lighting brightness at takeoff/middle flight/end of flight state, lavatory availability, Internet, purchasing products/services on Internet, credit limit for purchasing product/services on Internet sites, Internet sites/company sites pre-approved for browsing/purchasing products/services, number of crew/attendant availability for passenger service or the like.

During the flight, the passenger may upgrade the service level via an online portal or application provided by the IFEC system. This is shown in FIG. 1D as a “+” sign associated with different seats. In one aspect, data from the point of sale units on the aircraft is routed to ground systems 54 for future services and price decisions.

FIG. 1E shows an example of an innovative, processor executable process 28, according to one aspect of the present disclosure. The process begins in block B12, when the customer purchased fare data, seat location information, passenger loyalty data or any other information is retrieved by the configurator 58 of FIG. 1D.

In block B14, a digital rights file (shown as digital rights data structure 320 in FIG. 3, which may also include the seat specific feature access database 321) is generated and provided to the IFEC system. In block B16, an onboard configurator 58A (FIG. 3) configures the digital rights and seat specific feature access for each passenger service level based on the digital rights data structure 320 and the seat specific feature access database 321.

In one aspect, in block B18, the IFEC system presents options to the passenger to modify the digital rights i.e., upgrade the digital rights that are assigned by the digital rights data structure 320 and/or included in the seat specific feature access database 321. In one aspect, digitally upgrading/downgrading of functionality refers to the use of the seat specific feature access database 321, that may provide e.g., generic feature lock or unlock for specific seat for passenger usage/availability, such as displaying advertisements on the IFE directed to specified products/services, Bluetooth access and Wi-Fi access for tablets and mobile devices, power access for tablets or mobile devices, overhead storage bin availability for luggage storage and/or recent passenger purchases, lavatory availability, seat arm control functionality including availability for pairing with passenger Bluetooth devices, overhead lighting brightness at takeoff/middle flight/end of flight state, Internet, purchasing products/services on Internet, credit limit for purchasing product/services on Internet sites, Internet sites/company sites pre-approved for browsing/purchasing products/services, number of crew/attendant availability for passenger service or the like. This includes the modification of digital rights by a crew member, if a passenger has changed seats during the flight. The modification is implemented on the aircraft in block B20. Based on the modification, in block B22, digital content and seat specific feature/functionality is provided to the passenger via a seat device and/or a personal electronic device. It is noteworthy that if no modification is made, the process from block B16 moves directly to B22. Thereafter, in block B24, the data from the aircraft including upgrades, downgrades, content viewed by the passenger, and the functions used by the passenger are provided to the ground-based systems 54. This information can be used for future service level and pricing decisions.

FIG. 1F shows an example of another innovative, processor executable process 30, according to one aspect of the present disclosure. The process begins in block B32, when customer purchased fare data, seat location information, passenger loyalty data or any other information is retrieved by the configurator 58 before a flight.

In block B34, aircraft LOPA information, the functionality that is available on the aircraft, and media content attributes for the media content that will be made available on the aircraft is retrieved by the configurator 58. The media content attributes identify the media content, the source of the media content, the media content size, the media content duration and other attributes.

In block B36, the configurator 58 maps the functionality and the media content for each passenger and/or passenger seat location using, e.g., a weighting algorithm. The weighting algorithm uses a weighting scheme that assigns a numerical importance level for each parameter. Thereafter, configurator 58 generates the digital rights data structure 320 and the seat specific feature access database 321 and provides the same to the aircraft IFEC system. In one aspect, as described above, the IFEC system presents options to the passenger to modify the digital rights i.e., upgrade or downgrade the digital rights that are assigned by the digital rights data structure 320. This includes the modification of digital rights by a crew member if a passenger has changed seats during the flight. The modification is implemented on the aircraft. In one aspect, digitally upgrading/downgrading of functionality refers to the use of the seat specific feature access database 321, that provides e.g., generic feature lock or unlock for specific seat for passenger usage/availability, such as displaying advertisements on the IFE directed to specified products/services, Bluetooth access and Wi-Fi access for tablets and mobile devices, power access for tablets or mobile devices, overhead storage bin availability for luggage storage and/or recent passenger purchases, lavatory availability, seat arm control functionality including availability for pairing with passenger Bluetooth devices, overhead lighting brightness at takeoff/middle flight/end of flight state, Internet, purchasing products/services on Internet, credit limit for purchasing product/services on Internet sites, Internet sites/company sites pre-approved for browsing/purchasing products/services, number of crew/attendant availability for passenger service or the like.

In block B38, the onboard configurator 58A parses the digital rights data structure 320 and the seat specific feature access database 321 and maps digital content/functionality to each passenger and/or seat location. This may include a generic feature lock or unlock for specific seat for passenger usage/availability, such as displaying advertisements on the IFE directed to specified products/services, Bluetooth access and Wi-Fi access for tablets and mobile devices, power access for tablets or mobile devices, overhead storage bin availability for luggage storage and/or recent passenger purchases, lavatory availability, seat arm control functionality including availability for pairing with passenger Bluetooth devices, overhead lighting brightness at takeoff/middle flight/end of flight state, Internet, purchasing products/services on Internet, credit limit for purchasing product/services on Internet sites, Internet sites/company sites pre-approved for browsing/purchasing products/services, number of crew/attendant availability for passenger service or the like. Thereafter, in block B40, content and functionality are made available to the passenger via the IFEC system.

In one aspect, methods and systems are provided for a transportation vehicle. One method includes retrieving (B12, FIG. 1E/B32 and B34, FIG. 1F) information before a flight for an aircraft, the information including passenger fare purchase data, passenger seat location data, aircraft configuration defining a layout of the aircraft, functions available on the flight controlled by an in-flight entertainment (IFE) system; prior to the flight, generating (B14, FIG. 1E/B36, FIG. 1F) a digital rights object for the aircraft, the digital rights object defining media content and functionality that will be made available to each passenger at a passenger seat; uploading (B14, FIG. 1E) the digital rights object to the aircraft; parsing (B38, FIG. 1F) the digital rights object to map media content and functionality for each passenger seat; enabling (B18, FIG. 1E) by the IFE system, an upgrade or downgrade of digital rights of a passenger as defined by the digital rights object; updating (B20, FIG. 1E) mapping of media content and functionality for delivering media content and functionality, based on the upgrade or downgrade; and delivering (B22, FIG. 1E) media content and access to the functionality for the passenger, based on the upgrade or downgrade to the digital rights of the passenger.

It is noteworthy that the adaptive process blocks of FIGS. 1E and 1F can be executed in a different order than what is depicted. Furthermore, the process blocks can be executed by one or more processors.

Furthermore, the process blocks described above can be executed using cloud computing. Cloud computing means computing capability that provides an abstraction between a computing resource and its underlying technical architecture (e.g., servers, storage, and networks), enabling convenient, on-demand network access to a shared pool of configurable computing resources that may be rapidly provisioned and released with minimal management effort or service provider interaction. The term “cloud” herein is intended to refer to a network, for example, the Internet and cloud computing allows shared resources, for example, software and information to be available, on-demand, like a public utility.

Software applications (e.g., configurator 58) for cloud-based systems are typically built using “containers,” which may also be referred to as micro-services. Kubernetes is an open-source software platform for deploying, managing and scaling containers including configurator 58. As an example, Amazon Web Services (“AWS”) provided by Amazon Inc., Azure provided by Microsoft Corporation, Google Cloud Platform provided by Alphabet Inc. (without derogation of any trademark rights of Amazon Inc., Microsoft Corporation or Alphabet Inc.), or any other cloud platform can be used for building, testing, deploying, and managing applications and services including configurator 58. It is noteworthy that, the adaptive aspects of the present disclosure are not limited to any specific cloud platform.

The term micro-service as used herein denotes computing technology for providing a specific functionality via a cloud layer. As an example, configurator 58 and other modules of FIG. 1D are micro-services, deployed as containers (e.g., “Docker” containers), stateless in nature, may be exposed as a REST (representational state transfer) application programming interface (API) and are discoverable by other services. Docker is a software framework for building and running micro-services using the Linux operating system kernel (without derogation of any third-party trademark rights). As an example, when implemented as docker containers, docker micro-service code for configurator 58 is packaged as a “Docker image file”. A Docker container for configurator 58 is initialized using an associated image file. A Docker container is an active or running instantiation of a Docker image. Each Docker container provides isolation and resembles a lightweight virtual machine. It is noteworthy that many Docker containers can run simultaneously in a computing system. In one aspect, configurator 58 can be deployed from an elastic container registry (ECR). As an example, ECR is provided by AWS (without derogation of any third-party trademark rights) and is a managed container registry that stores, manages, and deploys container images. The various aspects described herein are not limited to the Linux kernel or using the Docker container framework.

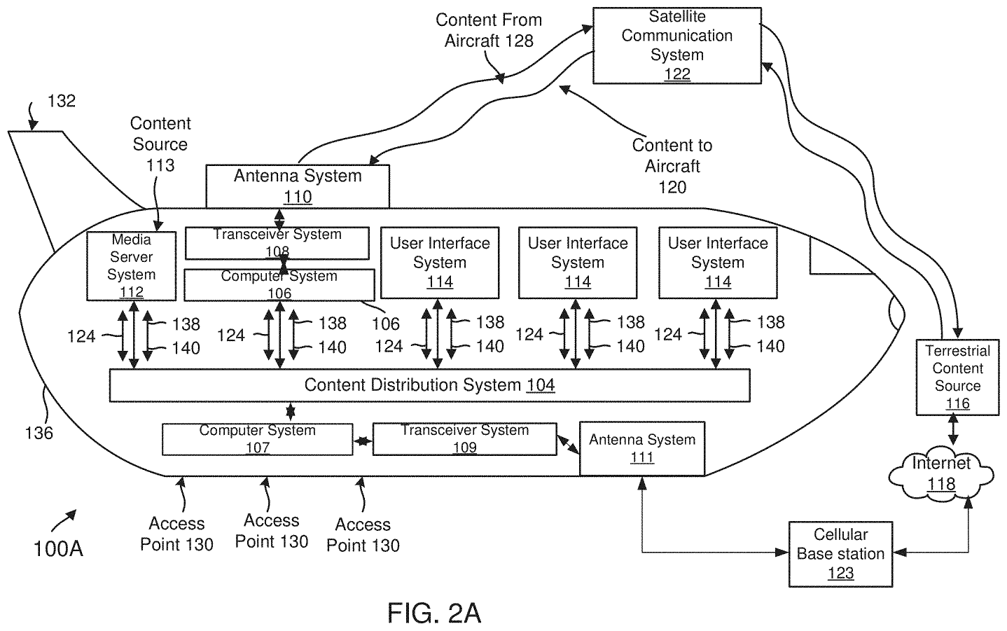

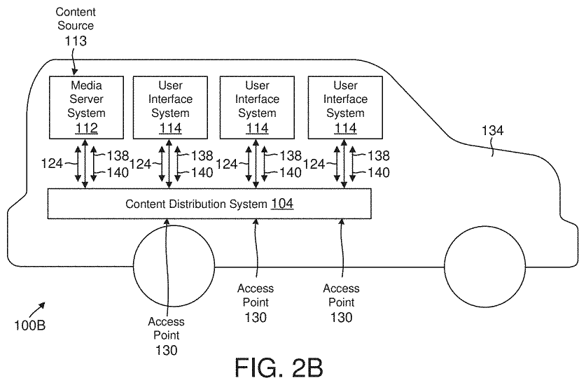

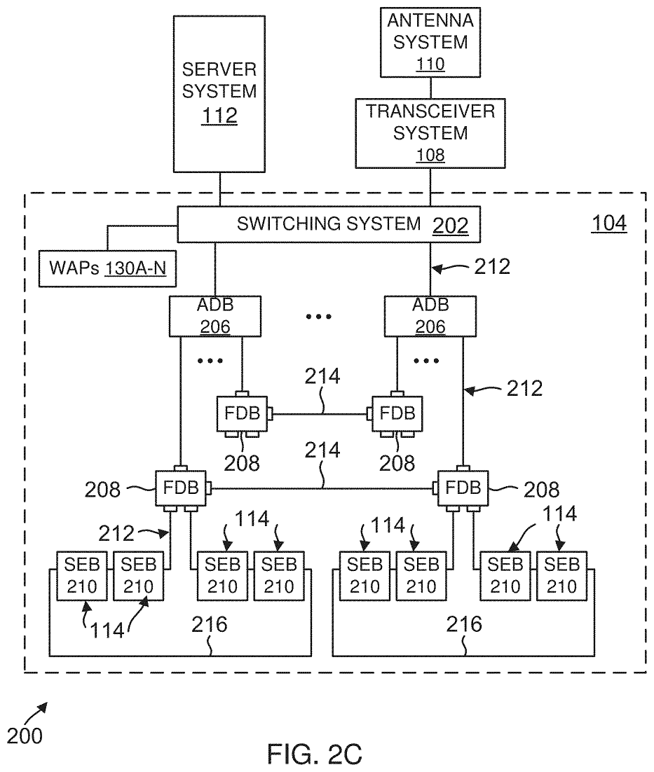

Vehicle Information System: FIG. 2A shows an example of a generic vehicle information system 100A (also referred to as system 100A) that can be configured for installation aboard an aircraft 132 for digital upgrades and downgrades described above, according to various aspects of the present disclosure. When installed on an aircraft, system 100A can comprise an aircraft passenger IFEC system, such as the Series 2000, 3000, eFX, eX2, eXW, eX3, NEXT, and/or any other IFEC system developed and provided by Panasonic Avionics Corporation (without derogation of any trademark rights of Panasonic Avionics Corporation) of Lake Forest, Calif., the assignee of this application.

System 100A comprises at least one content source 113 and one or more user (or passenger) interface systems (may also be referred to as a seat device/seatback device/smart monitor) 114 that communicate with a real-time content distribution system 104. The content sources 113 may include one or more internal content sources, such as a media server system 112, that are installed aboard the aircraft 132, one or more remote (or terrestrial) content sources 116 (including OTT content providers) that can be external from the aircraft 132, or a distributed content system. The media server system 112 can be provided as an information system controller for providing overall system control functions for system 100A and/or for storing viewing content 124, including pre-programmed viewing content and/or content 120 downloaded to the aircraft, as desired. The viewing content 124 can include television programming content, music content, podcast content, photograph album content, audiobook content, and/or movie content without limitation. The viewing content as shown and described herein are not exhaustive and are provided herein for purposes of illustration only and not for purposes of limitation.

The server system 112 can include, and/or communicate with, one or more conventional peripheral media storage systems (not shown), including storage class memory, optical media devices, such as a digital video disk (DVD) system or a compact disk (CD) system, and/or magnetic media systems, such as a solid state drive (SSD) system, or a hard disk drive (HDD) system, of any suitable kind, for storing the preprogrammed content and/or the downloaded content 120.

The viewing content 124 can comprise any conventional type of audio and/or video viewing content, such as stored (or time-delayed) viewing content and/or live (or real-time) viewing content. As desired, the viewing content 124 can include geographical information. Alternatively, and/or additionally, to entertainment content, such as live satellite television programming and/or live satellite radio programming and/or live wireless video/audio streaming, the viewing content likewise can include two-way communications, such as real-time access to the Internet 118 and/or telecommunications and/or the cellular base station 123 that communicates through an antenna 111 to a transceiver system 109, and a computer system 107 (similar to computer system 106). The functionality of computer system 107 is similar to computing system 106 for distributing content using the content distribution system 104 described herein. It is noteworthy that although two antenna systems 110/111 have been shown in FIG. 2A, the adaptive aspects disclosed herein may be implemented by fewer or more antenna systems.

Being configured to distribute and/or present the viewing content 124 provided by one or more selected content sources 113, system 100A can communicate with the content sources 113 in real time and in any conventional manner, including via wired and/or wireless communications. System 100A and the terrestrial content source 116, for example, can communicate directly and/or indirectly via an intermediate communication system, such as a satellite communication system 122 or the cellular base station 123.

System 100A can receive content 120 from a selected terrestrial content source 116 and/or transmit (upload) content 128, including navigation and other control instructions, to the terrestrial content source 116. As desired, the terrestrial content source 116 can be configured to communicate with other terrestrial content sources (not shown). The terrestrial content source 116 is shown as providing access to the Internet 118. Although shown and described as comprising the satellite communication system 122 and the cellular base station 123 for purposes of illustration, the communication system can comprise any conventional type of wireless communication system, such as any wireless communication system and/or an Aircraft Ground Information System (AGIS) communication system.

To facilitate communications with the terrestrial content sources 116, system 100A may also include an antenna system 110 and a transceiver system 108 for receiving the viewing content from the remote (or terrestrial) content sources 116. The antenna system 110 preferably is disposed outside, such as an exterior surface of a fuselage 136 of the aircraft 132. The antenna system 110 can receive viewing content 124 from the terrestrial content source 116 and provide the received viewing content 124, as processed by the transceiver system 108, to a computer system 106 of system 100A. The computer system 106 can provide the received viewing content 124 to the media (or content) server system 112 and/or directly to one or more of the user interfaces 114 including a PED, as desired, based on the digital rights data structure 320. Although shown and described as being separate systems for purposes of illustration, the computer system 106 and the media server system 112 can be at least partially integrated.

The user interface system 114 may be computing terminals in communication with an access point 130. The user interface system 114 provides a display device to view content for each passenger based on the digital rights data structure 320. The user interface system 114 includes a hardware interface to connect to an access point 130 that provides a wired and/or a wireless connection for the user interface system.

In at least one embodiment, the user interface system 114 comprises a software application that a user downloads and installs on a PED to receive and view content via an access point 130, described below in detail. While bandwidth limitation issues may occur in a wired system on a vehicle, such as an aircraft 132, in general the wired portion of the vehicle information 100A system is designed with sufficient bandwidth to support all users aboard the vehicle, i.e., passengers.

The user interface system 114 can include an input system (338, FIG. 3) for permitting the user (or also referred to as passenger) to communicate with system 100A, such as via an exchange of control signals 138. For example, the input system can permit the user to input one or more user instructions 140 for controlling the operation of system 100A as well as request digital upgrades and downgrades described above. Illustrative user instructions 140 can include instructions for initiating communication with the content source 113, instructions for selecting viewing content 124 for presentation, and/or instructions for controlling the presentation of the selected viewing content 124. If a fee is required for accessing the viewing content 124 or for any other reason (e.g., digital upgrades/downgrades) payment information likewise can be entered via the input system. The input system can be provided in any conventional manner and typically includes a touch screen, application programming interface (API), one or more switches (or pushbuttons), such as a keyboard or a keypad, and/or a pointing device, such as a mouse, trackball, or stylus.

In one aspect, the user interface system 114 is provided on individual passenger seats of aircraft 132. The user interface system 114 can be adapted to different aircraft and seating arrangements and the adaptive aspects described herein are not limited to any specific seat arrangements or user interface types.

FIG. 2B shows an example of implementing the vehicle information system 100B (may be referred to as system 100B) on an automobile 134 that may include a bus, a recreational vehicle, a boat, and/or a train, or any other type of passenger vehicle without limitation. The various components of system 100B may be similar to the components of system 100A described above with respect to FIG. 2A and for brevity are not described again. It is noteworthy that although the various examples of the innovative technology disclosed herein is based on aircrafts, the technology can be used on any transportation vehicle type, including ships, boats, trains and automobiles.

Content Distribution System: FIG. 2C illustrates an example of the content distribution system 104 for the vehicle information system 200 (similar to 100A/100B) based on the digital rights data structure 320, according to one aspect of the present disclosure. The content distribution system 104 couples, and supports communication between the server system 112, and the plurality of user interface systems 114.

The content distribution system 104, for example, can be provided as a conventional wired and/or wireless communication network, including a telephone network, a local area network (LAN), a wide area network (WAN), a campus area network (CAN), personal area network (PAN) and/or a wireless local area network (WLAN) of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16.

Preferably being configured to support high data transfer rates, the content distribution system 104 may comprise a high-speed Ethernet network, such as any type of Fast Ethernet (such as 100 Base-X and/or 100 Base-T) communication network and/or Gigabit (such as 1000 Base-X and/or 1000 Base-T) Ethernet communication network, with a typical data transfer rate of at least approximately one hundred megabits per second (100 Mbps) or any other transfer rate. To achieve high data transfer rates in a wireless communications environment, free-space optics (or laser) technology, millimeter wave (or microwave) technology, and/or Ultra-Wideband (UWB) technology can be utilized to support communications among the various system resources, as desired.

As illustrated in FIG. 2C, the distribution system 104 can be provided as a plurality of area distribution boxes (ADBs) 206, a plurality of floor disconnect boxes (FDBs) 208, and a plurality of seat electronics boxes (SEBs) (and/or video seat electronics boxes (VSEBs) and/or premium seat electronics boxes (PSEBs)) 210 being configured to communicate in real time via a plurality of wired and/or wireless communication connections 212.

The distribution system 104 likewise can include a switching system 202 for providing an interface between the distribution system 104 and the server system 112. The switching system 202 can comprise a conventional switching system, such as an Ethernet switching system, and is configured to couple the server system 112 with the ADBs 206. Each of the ADBs 206 is coupled with, and communicates with, the switching system 202. In addition, the distribution system 104 includes one or more wireless access points (WAPs) (130A to 130N) connected in communication with the switch system 202 for wireless distribution of content to user interface systems 114 including PEDs.

Each of the ADBs 202, in turn, is coupled with, and communicates with, at least one FDB 208. Although the ADBs 206 and the associated FDBs 208 can be coupled in any conventional configuration, the associated FDBs 208 preferably are disposed in a star network topology about a central ADB 206 as illustrated in FIG. 2C. Each FDB 208 is coupled with, and services, a plurality of daisy-chains of SEBs 210. The SEBs 210, in turn, are configured to communicate with the user interface systems 114. Each SEB 210 can support one or more of the user interface systems 114.

The switching systems 202, the ADBs 206, the FDBs 208, the SEBs (and/or VSEBs), and/or PSEBs) 210, the antenna system 110 (or 111), the transceiver system 108, the content source 113, the server system 112, and other system resources of the vehicle information system preferably are provided as line replaceable units (LRUs). The use of LRUs facilitate maintenance of the vehicle information system 200 because a defective LRU can simply be removed from the vehicle information system 200 and replaced with a new (or different) LRU. The defective LRU thereafter can be repaired for subsequent installation. Advantageously, the use of LRUs can promote flexibility in configuring the content distribution system 104 by permitting ready modification of the number, arrangement, and/or configuration of the system resources of the content distribution system 104. The content distribution system 104 likewise can be readily upgraded by replacing any obsolete LRUs with new LRUs.

The distribution system 104 can include at least one FDB internal port bypass connection 214 and/or at least one SEB loopback connection 216. Each FDB internal port bypass connection 214 is a communication connection 212 that permits FDBs 208 associated with different ADBs 206 to directly communicate. Each SEB loopback connection 216 is a communication connection 212 that directly couples the last SEB 210 in each daisy-chain of seat electronics boxes 210 for a selected FDB 208 as shown in FIG. 2C. Each SEB loopback connection 216 therefore forms a loopback path among the daisy-chained seat electronics boxes 210 coupled with the relevant FDB 208.

It is noteworthy that the various aspects of the present disclosure may be implemented without using FDB 208. When FDB 208 is not used, ADB 206 communicates directly with SEB 210 and/or server system 112 may communicate directly with SEB 210 or the seats. The various aspects of the present disclosure are not limited to any specific network configuration.

System 300: FIG. 3 shows an example of a system 300 for implementing the innovative computing technology of the present disclosure, according to various aspects of the present disclosure, described below in detail. In one aspect, system 300 includes an onboard management system 344, a seat device 326, a PED 302, and ground systems 54 that includes or has access to the airline loyalty database 62, passenger fare class data 66, the configurator 58, the IFEC digital rights manager 60 and the departure control system, 64, described above with respect to FIG. 1D. Furthermore, PED 302 may also be referred to as a crew device that enables a crew member to modify customer digital rights on the aircraft.

In one aspect, the onboard management system 344 includes a server 354 (similar to the media server 112 and/or computer system 106/107). The server 354 includes a processor 346 that has access to a memory 350 via a bus system/interconnect (similar to the interconnect 312 on seat device 326 described below in detail). The interconnect may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 346 includes one or more programmable, hardware-based, general-purpose or special-purpose microprocessors, digital signal processors (DSPs), programmable controllers, application specific integrated circuits (ASICs), programmable logic devices (PLDs), or the like, or a combination of such devices.

Processor 346 has access to storage (or storage device) 348 that may be used to store the digital rights data structure 320, the seat specific feature access database 321, passenger data 352, applications, and program files, including system software 356, an application 314 (also referred to as an airline application), and others. Storage 348 includes one or more magnetic or optical based disks, storage class memory, solid-state drive or any other storage device type. The seat specific access database 321 enables generic feature lock or unlock for specific seat for passenger usage/availability, such as displaying advertisements on the IFE directed to specified products/services, Bluetooth access and Wi-Fi access for tablets and mobile devices, power access for tablets or mobile devices, overhead storage bin availability for luggage storage and/or recent passenger purchases, lavatory availability, seat arm control functionality including availability for pairing with passenger Bluetooth devices, overhead lighting brightness at takeoff/middle flight/end of flight state, Internet, purchasing products/services on Internet, credit limit for purchasing product/services on Internet sites, Internet sites/company sites pre-approved for browsing/purchasing products/services, number of crew/attendant availability for passenger service, or the like.

In one aspect, application 314 may be downloaded from server 354 by passengers using an authorized PED 302 for accessing digital content based on individual digital rights as defined by the digital rights data structure 320 and the seat specific feature access database 321. In one aspect, system software 356 is executed by the processor 346 to control the overall operation of the server 354.

In one aspect, the onboard management system 344 maintains flight and passenger data 352 (may also be referred to as data 352 or passenger manifest), for example, flight itinerary including origin location, layover locations, destination location, language preference for translating messages from one language to another, arrival time and other information. Data 352 may also include passenger data that identifies each passenger for a flight, a seat assigned to a passenger, a language preference for the passenger, and any other information that can uniquely identify the passengers. Data 352 may be retrieved from the ground systems 54 before flight departure.

In one aspect, server 354 communicates with the ground systems 54, PED 302 and/or seat device 326 via a communication interface 358. The communication interface 358 may be used to receive information from the ground, for example, data structure 320 and passenger data 352. The communication interface 358 includes one or more interfaces for a wired and/or wireless connection, as described above with respect to FIGS. 2A/2C.

In one aspect, the seat device 326 includes a display device 330 to display content, based on the digital rights data structure 320, a processor 332, a memory 340, a seat device communication interface (also referred to as communication interface) 328 and storage (or storage device) 342 for storing content. Storage 342 stores content in a non-volatile manner, and includes one or more magnetic or optical based disks, storage class memory, flash memory, solid-state drive or any other storage device type. The seat device 326 may optionally include a camera 370 and a microphone 336. The camera may be used to take a picture, and the microphone 366 can be used for receiving a voice input to activate camera 330.

In one aspect, the seat device 326 receives user input/requests via an input module 338, e.g., for digital upgrades/downgrades, described above. The input module 338 may be configured to use a local touch screen included with display 330, a local virtual keyboard, an external mouse, external keyboard or any other input device.

In one aspect, processor 332 has access to memory 340 via an interconnect (or bus system) 312. Processor 332 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The interconnect 312 is an abstraction that represents any one or more separate physical buses and/or point-to-point connections, connected by appropriate bridges, adapters and/or controllers. The interconnect 312, therefore, may include, for example, a system bus, a Peripheral Component Interconnect (PCI) bus, a PCI-Express bus, a Hyper-Transport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

In one aspect, memory 340 stores application 314. This information can be stored in storage 342 and then moved to memory 340 when the processor 332 needs access.

In one aspect, processor 332 also executes an IFEC layer 334 out of memory 340. The IFEC layer 334 provides in-flight entertainment and other options to users, based on the digital rights in data structure 320. The IFEC layer 334 provides audio/video content as well as controls for accessing the content.

In one aspect, the IFEC layer 334 uses the seat device communication interface 328 to interface with the PED 302 and/or onboard management system 344. The communication interface 328 includes logic and circuitry for interfacing with the onboard management system 344 and/or PED 302. In one aspect, the communication interface 328 may use a wireless and/or wired connection for such communication.

In one aspect, the seat device 326 executes the application 314 that may be used by the passenger to view content or enable various computing functions, based on the digital rights data structure 320. The application 314 when executed by the seat device 326 may have different functionality compared to when application 314 is executed by the PED 302.

The seat device 326 on the aircraft may be part of the user interface system 114 or interfaces with the user interface system 114 also described above with respect to FIGS. 2A/2B. It is noteworthy that the seat device 326 need not be mounted on the back of a seat and may be supported from other structures, such as a bulkhead, wall, arm of a seat, etc. The adaptive aspects of the present disclosure are not limited to any specific location or orientation of the seat device 326.

In one aspect, the PED 302 may be a mobile phone, a notebook, a tablet, a laptop or any other computing device. The PED 302 is securely paired with the seat device 326 using application 314 to access the functionality offered by the seat device 326. The term “pair”, and other grammatical forms such as “pairing”, means that the PED 302 is associated with a particular passenger seat such that communications received by seat device 326 from the PED 302 are recognized as being related to that passenger seat and/or such communications control seat functions associated with a passenger seat and controlled by a seat function controller. The term automatic as associated with pairing means that the PED is paired with minimal passenger involvement.

As an example, PED 302 may include a processor 306 that has access to a memory 310 via a bus system/interconnect (similar to 312 on the seat device 326) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 306 may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

PEDs 302 may include a microphone 336 for receiving a voice input from a passenger. In another aspect, PED 302 also includes a camera 370 that may be used by a passenger to upload a video.

Processor 306 has access to storage (or storage device) 316 that includes any storage medium for storing data in a non-volatile manner, such as one or more magnetic or optical based disks, storage class memory, flash memory, or solid-state drive. The storage device 316 may be used to store content displayed on a display 304 of PED 302 when used by a passenger. In one aspect, display 304 may also include a touch screen for receiving input commands, e.g., to execute digital upgrades/downgrades, described above in detail.

The storage device 316 may also store the application 314 executed out of memory 310. Application 314 may be used to pair the PED 302 with seat device 326 to receive digital content and communicate with the seat device 326.

Furthermore, as an example, application 314 may be made available for download and installation via a public repository such as that maintained respectively under the trademark GOOGLE PLAY by Google, Inc. and/or the APP STORE maintained by Apple Inc. In addition, application 314 may be provided for download by an airline carrier on a website or from the onboard management system 344.

In one aspect, PED 302 uses a PED communication module 308 to communicate with the seat device 326. In one aspect, the PED communication module 308 may include one or more interfaces to communicate with different devices, including Wi-Fi interface, Bluetooth interface, NFC (Near Field Communication) interface and others. The adaptive aspects described herein are not limited to any specific interface. It is noteworthy that although a single block is shown for the PED communication module 308 for convenience, the communication module may have different interface, cards, logic and circuitry to comply with the different communication protocols/standards.

In one aspect, server 354 communicates with the ground systems 54 via a network connection. The network connection can be a satellite-based network connection or use any other technology. The ground systems 54 may include one or more processors (similar to processor 346) that has access to a memory (similar to 350) via a bus system/interconnect (similar to 312) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

The ground systems processor may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

The ground system 54 may also include a storage (or storage device) that may be or may include any storage medium for storing data in a non-volatile manner, such as one or more magnetic or optical based disks, flash memory, or solid-state drive. The storage device may be used to store airline loyalty database 62, fare class data 66 and the data structures 320/321.

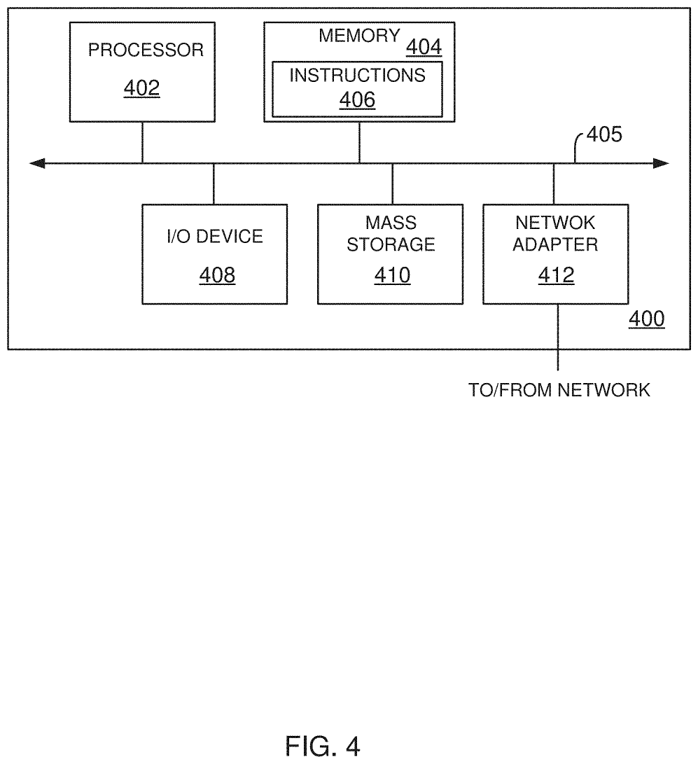

Processing System: FIG. 4 is a high-level block diagram showing an example of the architecture of a processing system 400 that may be used according to one aspect. The processing system 400 can represent the ground systems 54, media server 112, computing system 106/107, WAP 130, onboard management system 344, seat device 326 or any user device (PED 302) that attempts to interface with a vehicle computing device. Note that certain standard and well-known components which are not germane to the present aspects are not shown in FIG. 4.

The processing system 400 includes one or more processor(s) 402 and memory 404, coupled to a bus system 405. The bus system 405 shown in FIG. 4 is an abstraction that represents any one or more separate physical buses and/or point-to-point connections, connected by appropriate bridges, adapters and/or controllers. The bus system 405, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

The processor(s) 402 are the central processing units (CPUs) of the processing system 400 and, thus, control its overall operation. In certain aspects, the processors 402 accomplish this by executing software stored in memory 404. A processor 402 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 404 represents any form of random access memory (RAM), read-only memory (ROM), flash memory, or the like, or a combination of such devices. Memory 404 includes the main memory of the processing system 400. Instructions 406 may be used to implement application 314, data structure 320 and/or the process steps of FIGS. 1E-1F, as described above.

Also connected to the processors 402 through the bus system 405 are one or more internal mass storage devices 410, and a network adapter 412. Internal mass storage devices 410 may be or may include any conventional medium for storing large volumes of data in a non-volatile manner, such as one or more magnetic or optical based disks, flash memory, or solid-state drive.

The network adapter 412 provides the processing system 400 with the ability to communicate with remote devices (e.g., over a network) and may be, for example, an Ethernet adapter or the like.

The processing system 400 also includes one or more input/output (I/O) devices 408 coupled to the bus system 405. The I/O devices 408 may include, for example, a display device, a keyboard, a mouse, etc. The I/O device may be in the form of a handset having one or more of the foregoing components, such as a display with a real or virtual keyboard, buttons, and/or other touch-sensitive surfaces.

As an example, the terms “component”, “module”, “system”, and the like as used herein are intended to refer to a computer-related entity, either software-executing general-purpose processor, hardware, firmware or a combination thereof. For example, a component may be, but is not limited to being, a process running on a hardware processor, a hardware processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer/machine readable media including, but not limited to, an ASIC (application specific integrated circuit), CD (compact disc), DVD (digital video disk), ROM (read only memory), hard disk, EEPROM (electrically erasable programmable read only memory), solid state memory device or any other storage device, in accordance with the claimed subject matter.

Thus, methods and systems for digital upgrades/downgrades on transportation vehicles have been described. Note that references throughout this specification to “one aspect” (or “embodiment”) or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements.

What is claimed is:

1. A method executed by one or more processors, comprising:
retrieving information before a flight for an aircraft, the information including passenger fare purchase data, passenger seat location data, aircraft configuration defining a layout of the aircraft, functions available on the flight controlled by an in-flight entertainment (IFE) system;
prior to the flight, generating a digital rights object for the aircraft, the digital rights object defining media content and functionality that will be made available to each passenger at a passenger seat;
uploading the digital rights object to the aircraft;
parsing the digital rights object to map media content and functionality for each passenger seat;
enabling by the IFE system, an upgrade or downgrade of digital rights of a passenger as defined by the digital rights object;
updating mapping of media content and functionality for delivering media content and functionality, based on the upgrade or downgrade; and
delivering media content and access to the functionality for the passenger, based on the upgrade or downgrade to the digital rights of the passenger.

2. The method of claim 1, further comprising:
modifying, by a crew device, the digital rights of the passenger based on a passenger seat change.

3. The method of claim 1, further comprising:
unlocking a feature lock to enable access to a function for the passenger, in response to the upgrade of the digital rights.

4. The method of claim 1, further comprising:
locking a feature lock to deny access to a function to the passenger, in response to the downgrade of the digital rights.

5. The method of claim 1, wherein the upgraded or downgraded functionality involves displaying advertisements by the IFE system for one or more products.

6. The method of claim 1, wherein the upgraded or downgraded functionality involves pairing a passenger electronic device to the IFE system.

7. The method of claim 1, wherein the upgraded or downgraded functionality involves network access to one or more passenger devices.

8. A non-transitory storage medium having stored thereon instructions for performing a method, comprising machine executable code, which when executed by at least one machine, causes the machine to:
retrieve information before a flight for an aircraft, the information including passenger fare purchase data, passenger seat location data, aircraft configuration defining a layout of the aircraft, functions available on the flight controlled by an in-flight entertainment (IFE) system;
prior to the flight, generate a digital rights object for the aircraft, the digital rights object defining media content and functionality that will be made available to each passenger at a passenger seat;
upload the digital rights object to the aircraft;
parse the digital rights object to map media content and functionality for each passenger seat;
enable by the IFE system, an upgrade or downgrade of digital rights of a passenger as defined by the digital rights object;
update mapping of media content and functionality for delivering media content and functionality, based on the upgrade or downgrade; and
deliver media content and access to the functionality for the passenger, based on the upgrade or downgrade to the digital rights of the passenger.

9. The non-transitory storage medium of claim 8, wherein the machine executable code, which when executed by at least one machine, further causes the machine to:
modify, by a crew device, the digital rights of the passenger based on a passenger seat change.

10. The non-transitory storage medium of claim 8, wherein the machine executable code, which when executed by at least one machine, further causes the machine to:
unlock a feature lock to enable access to a function for the passenger, in response to the upgrade of the digital rights.

11. The non-transitory storage medium of claim 8, wherein the machine executable code, which when executed by at least one machine, further causes the machine to:
lock a feature lock to deny access to a function to the passenger, in response to the downgrade of the digital rights.

12. The non-transitory storage medium of claim 8, wherein the upgraded or downgraded functionality involves displaying advertisements by the IFE system for one or more products.

13. The non-transitory storage medium of claim 8, wherein the upgraded or downgraded functionality involves pairing a passenger electronic device to the IFE system.

14. The non-transitory storage medium of claim 8, wherein the upgraded or downgraded functionality involves network access to one or more passenger devices.

15. A system, comprising:
a memory containing machine readable medium comprising machine executable code having stored thereon instructions; and a processor coupled to the memory to execute the machine executable code to:
retrieve information before a flight for an aircraft, the information including passenger fare purchase data, passenger seat location data, aircraft configuration defining a layout of the aircraft, functions available on the flight controlled by an in-flight entertainment (IFE) system;
prior to the flight, generate a digital rights object for the aircraft, the digital rights object defining media content and functionality that will be made available to each passenger at a passenger seat;
upload the digital rights object to the aircraft;
parse the digital rights object to map media content and functionality for each passenger seat;
enable by the IFE system, an upgrade or downgrade of digital rights of a passenger as defined by the digital rights object;
update mapping of media content and functionality for delivering media content and functionality, based on the upgrade or downgrade; and
deliver media content and access to the functionality for the passenger, based on the upgrade or downgrade to the digital rights of the passenger.

16. The system of claim 15, wherein the machine executable code further causes to:
modify, by a crew device, the digital rights of the passenger based on a passenger seat change.

17. The system of claim 15, wherein the machine executable code further causes to:
unlock a feature lock to enable access to a function for the passenger, in response to the upgrade of the digital rights.

18. The system of claim 15, wherein the machine executable code further causes to: lock a feature lock to deny access to a function to the passenger, in response to the downgrade of the digital rights.

19. The system of claim 15, wherein the upgraded or downgraded functionality involves pairing a passenger electronic device to the IFE system.

20. The system of claim 15, wherein the upgraded or downgraded functionality involves displaying advertisements by the IFE system for one or more products.
